(19) United States
(12) Patent Application Publication
(10) Pub. No.: US 2015/0265998 A1
(43) Pub. Date: Sep. 24, 2015

(54) ELECTRODE AND ELECTRODE STRUCTURAL BODY

(71) Applicant: NGK INSULATORS, LTD., Nagoya-City (JP)

(72) Inventors: Yoshimasa KONDO, Nagoya-City (JP); Shoji YOKOI, Nagoya-City (JP); Tatsuya TERAZAWA, Kasugai-City (JP); Naoya TAKASE, Konan-City (JP)

(21) Appl. No.: 14/630,957

(22) Filed: Feb. 25, 2015

(30) Foreign Application Priority Data
Mar. 20, 2014 (JP) 2014-058387

(51) Int. Cl. B01J 19/08; C01B 13/11

(52) U.S. Cl. CPC B01J 19/088; C01B 13/115; B01J 2219/0809; B01J 2219/0815; B01J 2219/083

(57) ABSTRACT

An electrode structural body includes a first electrode and a second electrode, and further includes a first retainer and a second retainer for fixing the first electrode and the second electrode. The first electrode and the second electrode are separated from each other, their axial directions being parallel to each other. The first electrode contains a first insulating body having a first hollow portion and a first conducting body located in the first hollow portion. The second electrode contains a second insulating body having a second hollow portion and a second conducting body located in the second hollow portion. At least in the first electrode, at least one end surface of the first conducting body is positioned inside the first hollow portion at a distance from one end surface of the first insulating body.

### CROSS-REFERENCE TO RELATED APPLICATION

This application is based upon and claims the benefit of priority from Japanese Patent Application No. 2014-058387 filed on Mar. 20, 2014, the contents of which are incorporated herein by reference.

### BACKGROUND OF THE INVENTION

1. Field of the Invention:

The present invention relates to an electrode and an electrode structural body containing an insulating body and a conducting body suitable for use, e.g., in a dielectric-barrier discharge electrode or an ozone generator.

2. Description of the Related Art:

For example, low-temperature plasma generators described in Japanese Laid-Open Patent Publication No. 08-185955 and International Publication No. WO 2008/108331 have been known as a structural body containing an insulating body and a conductive material.

In the low-temperature plasma generator described in Japanese Laid-Open Patent Publication No. 08-185955, a rod-shaped conducting body is inserted into a through-hole extending in a longitudinal direction in a rod-shaped ceramic dielectric body, and both ends of the conducting body and the ceramic dielectric body are integrally bonded and sealed with a glass or an inorganic or organic adhesive to form an electrode. In particular, in a case where the ceramic dielectric bodies of a plurality of the electrodes are bonded in a line contact state, a surface treatment agent containing a member selected from the group consisting of a metallic element, a rare-earth element, an inorganic salt, and an organic metallic compound including one of such elements is applied on surfaces of the rod-shaped conductive bodies or the rod-shaped ceramic dielectric bodies, and the applied agent is subjected to a heat treatment for bonding.

In the low-temperature plasma generator described in International Publication No. WO 2008/108331, a conducting paste is closely attached to at least an inner surface of a space defined inside an insulating body, and the conducting paste is enclosed in the space to form a continuous part of the conducting paste as a discharge electrode.

### SUMMARY OF THE INVENTION

However, the electrode described in Japanese Laid-Open Patent Publication No. 08-185955 is obtained by bonding the separately prepared conducting body and insulating body with a sealant such as a resin. Therefore, when a boundary between the insulating body and the sealant is deteriorated due to temperature change or the like, the insulation strength is significantly reduced.

In the electrode described in International Publication No. WO 2008/108331, the pipe-like discharge electrode of the conducting film, formed in the pipe-like insulating body, filled with an insulating substance. A silicone having sufficient insulation property and heat resistance (such as a silicone potting material) is used as the insulating substance and is attached firmly to the conducting film. Therefore, the insulating substance is disadvantageously deteriorated due to ozone generation.

In Japanese Laid-Open Patent Publication No. 08-185955 and International Publication No. WO 2008/108331, the electric field strength is increased at the boundary between a portion having the sealant and a portion not having the sealant, and undesirable creeping discharge is often caused. This leads to high energy loss and affects the durability.

When a discharge gap is formed between dielectric bodies such as the pipe-like insulating bodies, a retainer may be used for fixing the dielectric bodies. In this case, the retainer needs to have a large size to maintain a sufficient creepage distance. Therefore, the structural body is often complicated, and the creepage is disadvantageously deteriorated.

The present invention has been made in view of the above problems, an object of the present invention is to provide an electrode and an electrode structural body capable of achieving at least the following advantageous operational effects:
(a) generation of unnecessary discharge, which affects the energy loss and durability, can be prevented;
(b) in the case of using a retainer, the creepage distance on the retainer can be reduced, whereby the total size can be reduced; and
(c) the electric field can be lowered in a portion fixed by the retainer, whereby the structural body of the retainer can be simplified.

[1] According to a first aspect of the present invention, there is provided an electrode comprising a cylindrical insulating body having a hollow portion and a conducting body located in the hollow portion of the insulating body, wherein at least one end surface of the conducting body is positioned inside the hollow portion at a distance from one end surface of the insulating body.

[2] In the first aspect, a substance, which has a permittivity lower than that of the insulating body, may be present between the one end surface of the conducting body and the one end surface of the insulating body in the hollow portion.

[3] In the first aspect, the substance may be air.

[4] In the first aspect, the insulating body and the conducting body may be directly integrated with each other by firing.

[5] According to a second aspect of the present invention, there is provided an electrode structural body comprising a first electrode containing a cylindrical first insulating body having a first hollow portion and a first conducting body located in the first hollow portion of the first insulating body, a second electrode containing a cylindrical second insulating body having a second hollow portion and a second conducting body located in the second hollow portion of the second insulating body, and a retainer configured to fix the first electrode and the second electrode, wherein the first electrode and the second electrode are separated from each other, their axial directions being parallel to each other, and at least in the first electrode, at least one end surface of the first conducting body is positioned inside the first hollow portion at a distance from one end surface of the first insulating body.

[6] In the second aspect, a substance, which has a permittivity lower than that of the first insulating body, may be present between the one end surface of the first conducting body and the one end surface of the first insulating body in the first hollow portion.

[7] In the second aspect, at least the retainer may be located on outer peripheries of the first insulating body and the second insulating body between a position corresponding to the one end surface of the first insulating body and a position corresponding to the one end surface of the first conducting body.

[8] In the feature [5], in the second electrode, at least another end surface of the second conducting body may be positioned inside the second hollow portion at a distance from another end surface of the second insulating body. Among both of the end surfaces of the second conducting body, one end surface of the second conducting body is oriented in the same direction as the one end surface of the first conducting body, and the other end surface of the second conducting body is oriented in the opposite direction. Similarly, among both of the end surfaces of the second insulating body, one end surface of the second insulating body is oriented in the same direction as the one end surface of the first insulating body, and the other end surface of the second insulating body is oriented in the opposite direction.

[9] In this case, a substance, which has a permittivity lower than that of the first insulating body, may be present between the one end surface of the first conducting body and the one end surface of the first insulating body in the first hollow portion, and a substance, which has a permittivity lower than that of the second insulating body, may be present between the other end surface of the second conducting body and the other end surface of the second insulating body in the second hollow portion.

[10] In the feature [8] or [9], the retainer may contain a first retainer and a second retainer, the first retainer may be located on the outer peripheries of the first insulating body and second insulating body between a position corresponding to the one end surface of the first insulating body and a position corresponding to the one end surface of the first conducting body, and the second retainer may be located on the outer peripheries of the first insulating body and second insulating body between a position corresponding to the other end surface of the second insulating body and a position corresponding to the other end surface of the second conducting body.

[11] In the feature [6] or [9], the substance may be air.

[12] In the second aspect, the first insulating body and the first conducting body may be directly integrated with each other by firing, and the second insulating body and the second conducting body may be directly integrated with each other by firing. The electrode and the electrode structural body of the present invention can achieve the following advantageous effects:
(a) the generation of the unnecessary discharge, which affects the energy loss and durability, can be prevented;
(b) in the case of using the retainer, the creepage distance on the retainer can be reduced, whereby the total size can be reduced; and
(c) the electric field can be lowered in the portion fixed by the retainer, whereby the structural body of the retainer can be simplified.

The above and other objects, features and advantages of the present invention will become more apparent from the following description when taken in conjunction with the accompanying drawings in which preferred embodiments of the present invention are shown by way of illustrative example.

### BRIEF DESCRIPTION OF THE DRAWINGS

FIG. 1 is a cross-sectional view of an electrode structural body according to an embodiment of the present invention;

FIG. 2A is an explanatory view illustrating a problem of an electrode structural body according to a comparative example;

FIG. 2B is an explanatory view illustrating an advantageous effect of the electrode structural body of this embodiment;

FIG. 3A is a map of equipotential lines in a main part of Example 1;

FIG. 3B is a map of equipotential lines in a main part of Reference Example 1;

FIG. 4A is an enlarged map of equipotential lines in a main part of Example 1;

FIG. 4B is an enlarged map of equipotential lines in a main part of Reference Example 1;

FIG. 5A is a map of equipotential lines in a main part of Example 2;

FIG. 5B is a map of equipotential lines in a main part of Reference Example 2;

FIG. 6A is a map of equipotential lines in a main part of Example 3;

FIG. 6B is a map of equipotential lines in a main part of Reference Example 3;

FIG. 7A is an enlarged map of equipotential lines in a main part of Example 3;

FIG. 7B is an enlarged map of equipotential lines in a main part of Reference Example 3;

FIG. 8A is a cross-sectional view of an electrode structural body according to a first modification example;

FIG. 8B is a cross-sectional view of an electrode structural body according to a second modification example;

FIG. 9 is a flow chart of a first production method for producing a first electrode;

FIG. 10A is a cross-sectional view of a green body prepared in a green body preparation step;

FIG. 10B is a cross-sectional view of a preliminarily-fired body prepared in a preliminarily-fired body preparation step;

FIG. 10C is a cross-sectional view of a first conducting rod inserted into a hollow portion of the preliminarily-fired body in a conducting body insertion step;

FIG. 10D is a cross-sectional view of a first electrode produced in a firing/integration step;

FIG. 11 is a flow chart of a second production method for producing a first electrode;

FIG. 12A is a cross-sectional view of a green body prepared in a green body preparation step;

FIG. 12B is a cross-sectional view of a first conducting rod inserted into a hollow portion of the green body in a conducting body insertion step; and

FIG. 12C is a cross-sectional view of a first electrode produced in a firing/integration step.

### DESCRIPTION OF THE PREFERRED EMBODIMENTS

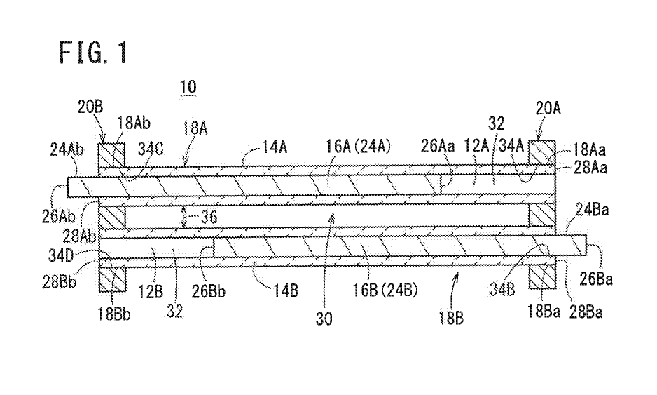

An embodiment of the electrode and the electrode structural body of the present invention will be described below with reference to FIGS. 1 to 12C. It should be noted that, in this description, a numeric range of “A to B” includes both the numeric values A and B as the lower limit and upper limit values.

As shown in FIG. 1, an electrode structural body 10 according to this embodiment contains a first electrode 18A and a second electrode 18B, and further contains a first retainer 20A and a second retainer 20B for fixing the first electrode 18A and the second electrode 18B. The first electrode 18A and the second electrode 18B are separated from each other in such a manner that their axial directions are parallel to each other.

The first electrode 18A contains a cylindrical first insulating body 14A having a first hollow portion 12A and a first conducting body 16A located in the first hollow portion 12A of the first insulating body 14A. The first insulating body 14A and the first conducting body 16A are directly integrated with each other by firing. The second electrode 18B contains a cylindrical second insulating body 14B having a second hollow portion 12B and a second conducting body 16B located in the second hollow portion 12B of the second insulating body 14B. The second insulating body 14B and the second conducting body 16B are directly integrated with each other by firing. The first insulating body 14A and the second insulating body 14B may be referred to as a dielectric body for inducing a charge.

In the example of FIG. 1, the first hollow portion 12A in the cylindrical first insulating body 14A and the second hollow portion 12B in the cylindrical second insulating body 14B are through-holes, and rods of the first conducting body 16A and the second conducting body 16B (hereinafter referred to as a first conducting rod 24A and a second conducting rod 24B) are inserted into the through-holes, respectively. The through-holes in the first insulating body 14A and the second insulating body 14B each have a circular cross-sectional shape, and similarly the first conducting rod 24A and the second conducting rod 24B each have a circular cross-sectional shape. Each of the first insulating body 14A and the second insulating body 14B has an outer diameter of 0.4 to 5 mm, an axial direction length of 5 to 100 mm, and a thickness of 0.1 to 1.5 mm. Each of the first conducting rod 24A and the second conducting rod 24B has an outer diameter of 0.2 to 4.6 mm and an axial direction length of 7 to 300 mm.

In the first electrode 18A of the electrode structural body 10, one end surface 26Aa of the first conducting rod 24A is positioned inside the first hollow portion 12A at a distance from one end surface 28Aa of the first insulating body 14A. Another end surface 26Ab of the first conducting rod 24A protrudes from another end surface 28Ab of the first insulating body 14A. Similarly, in the second electrode 18B, another end surface 26Bb of the second conducting rod 24B is positioned inside the second hollow portion 12B at a distance from another end surface 28Bb of the second insulating body 14B. One end surface 26Ba of the second conducting rod 24B protrudes from one end surface 28Ba of the second insulating body 14B. Another end 24Ab of the first conducting rod 24A and one end 24Ba of the second conducting rod 24B are electrically connected to a power supply (not shown) and act as extraction electrodes. The first conducting rod 24A and the second conducting rod 24B face each other in a discharge generation portion 30.

In the first hollow portion 12A of the first insulating body 14A, an air 32, which has a permittivity lower than that of the first insulating body 14A, is present between the one end surface 26Aa of the first conducting rod 24A and the one end surface 28Aa of the first insulating body 14A. Similarly, in the second hollow portion 12B of the second insulating body 14B, the air 32, which has a permittivity lower than that of the second insulating body 14B, is present between the other end surface 26Bb of the second conducting rod 24B and the other end surface 28Bb of the second insulating body 14B.

The first retainer 20A has a first through-hole 34A for one end 18Aa of the first electrode 18A and a second through-hole 34B for one end 18Ba of the second electrode 18B. Thus, in the first retainer 20A, the one end 18Aa of the first electrode 18A is inserted into the first through-hole 34A, and the one end 18Ba of the second electrode 18B inserted into the second through-hole 34B. The first retainer 20A is located on the outer peripheries of the first insulating body 14A and the second insulating body 14B between a position corresponding to the one end surface 28Aa of the first insulating body 14A and a position corresponding to the one end surface 26Aa of the first conducting rod 24A.

The second retainer 20B has a third through-hole 34C for another end 18Ab of the first electrode 18A and a fourth through-hole 34D for another end 18Bb of the second electrode 18B. Thus, in the second retainer 20B, the other end 18Ab of the first electrode 18A is inserted into the third through-hole 34C, and the other end 18Bb of the second electrode 18B is inserted into the fourth through-hole 340. The second retainer 20B is located on the outer peripheries of the first insulating body 14A and the second insulating body 14B between a position corresponding to the other end surface 28Bb of the second insulating body 14B and a position corresponding to the other end surface 26Bb of the second conducting rod 24B.

Consequently, the axial directions of the first electrode 18A and the second electrode 18B are arranged parallel to each other, and the first electrode 18A and the second electrode 18B are fixed at a predetermined discharge gap 36 (e.g., 0.3 to 1.0 mm).

Each of the first conducting body 16A (the first conducting rod 24A) and the second conducting body 16B (the second conducting rod 24B) is preferably made of a material containing a substance selected from the group consisting of molybdenum, tungsten, silver, copper, nickel, and alloys containing at least one thereof. Examples of such alloys include invar, kovar, inconel (registered trademark), incoloy (registered trademark).

Each of the first insulating body 14A and the second insulating body 14B is preferably made of a ceramic material that can be fired at a temperature lower than the melting points of the first conducting body 16A and the second conducting body 16B. Examples of such materials include single-metal oxide, single-metal nitride, composite oxide, or composite nitride material containing one or more substances selected from the group consisting of barium oxide, bismuth oxide, titanium oxide, zinc oxide, neodymium oxide, titanium nitride, aluminum nitride, silicon nitride, alumina, silica, and mullite. Among them, the composite oxide materials and the composite nitride materials are particularly preferred.

The operational advantages of the electrode structural body 10 will be described as compared with structural body according to a comparative example and reference examples.

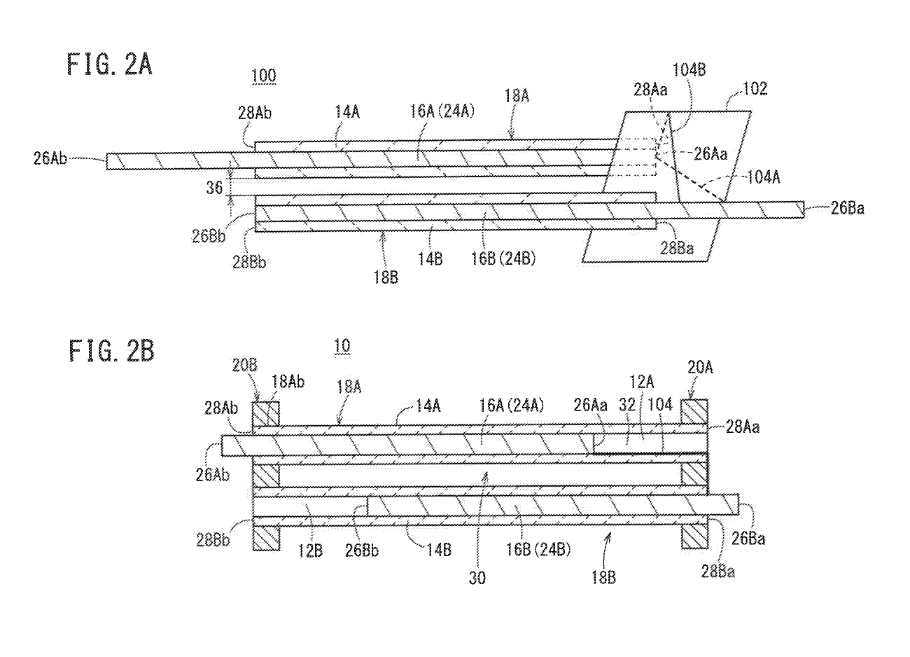

As shown in FIG. 2A, in an electrode structural body 100 according to the comparative example, the one end surface 26Aa of the first conducting rod 24A corresponds with the one end surface 28Aa of the first insulating body 14A in the first electrode 18A, and the other end surface 26Bb of the second conducting rod 24B corresponds with the other end surface 28Bb of the second insulating body 14B in the second electrode 18B.

A plate member 102 made of a resin or the like is interposed between the first electrode 18A and the second electrode 18B to maintain the discharge gap 36 between the first electrode 18A and the second electrode 18B. In this case, creepage paths between the first electrode 18A and the second electrode 18B include a first path 104A, a second path 104B, etc. The first path 104A extends from the end of the first electrode 18A through one surface of the plate member 102 to the second conducting rod 24B protruded from the second electrode 18B. The second path 104B extends from the end of the first electrode 18A through one surface and the other surface of the plate member 102 to the second conducting body 16B protruded from the second electrode 18B. Thus, in the electrode structural body 100 of the comparative example, the plate member 102 needs to have a large size to maintain a predetermined creepage distance. Consequently, the size of the electrode structural body 100 is disadvantageously increased.

In the electrode structural body 100 of the comparative example, a sealant made of a resin or the like is required for fixing the first electrode 18A, the second electrode 18B, and the plate member 102. In this case, because of the high permittivity of the sealant, the electric field is increased in the sealed portion, whereby an unnecessary discharge is generated in a gap or void in the sealant. This leads to high energy loss and affects the durability. Therefore, in the case of using the sealant, a vacuum defoaming step or the like is required for preventing formation of the gap or void, thereby resulting in a complicated process.

Furthermore, in the electrode structural body 100 of the comparative example, the insulating body, the sealant, and the plate member are disposed in the creepage portion. Therefore, a stress is generated due to the thermal expansion coefficient difference, whereby the sealant tends to be readily deteriorated.

In contrast, as shown in FIG. 2B, in the electrode structural body 10 of this embodiment, a creepage path 104 between the first electrode 18A and the second electrode 18B extends from the end of the first conducting rod 24A in the first electrode 18A through the first hollow portion 12A and the first retainer 20A to the second conducting rod 24B protruded from the second electrode 18B. In this case, the creepage distance of the assembled body substantially corresponds to a distance obtained by subtracting the distance between the one end surface 26Aa of the first conducting rod 24A and the one end surface 28Aa of the first insulating body 14A. In addition, in the first hollow portion 12A of the first electrode 18A, the air 32 having the lower permittivity is present between the one end surface 26Aa of the first conducting rod 24A and the one end surface 28Aa of the first insulating body 14A. Therefore, the electric field can be lowered in a portion of the first electrode 18A fixed by the first retainer 20A, whereby the creepage distance between the one end surface 26Aa of the first conducting rod 24A and the one end surface 28Aa of the first insulating body 14A can be reduced. Consequently, it is not necessary to increase the size of the first retainer 20A and the second retainer 20B. Thus, the electrode structural body 10 can be a smaller size.

Furthermore, in the electrode structural body 10, the creepage portion corresponds to the boundary between the air 32 and the insulating body. Thus, unlike the comparative example, the creepage portion is not formed between solids. Therefore, the stress due to the thermal expansion coefficient difference is hardly generated, and each component is hardly deteriorated.

In each of electrode structural bodies according to

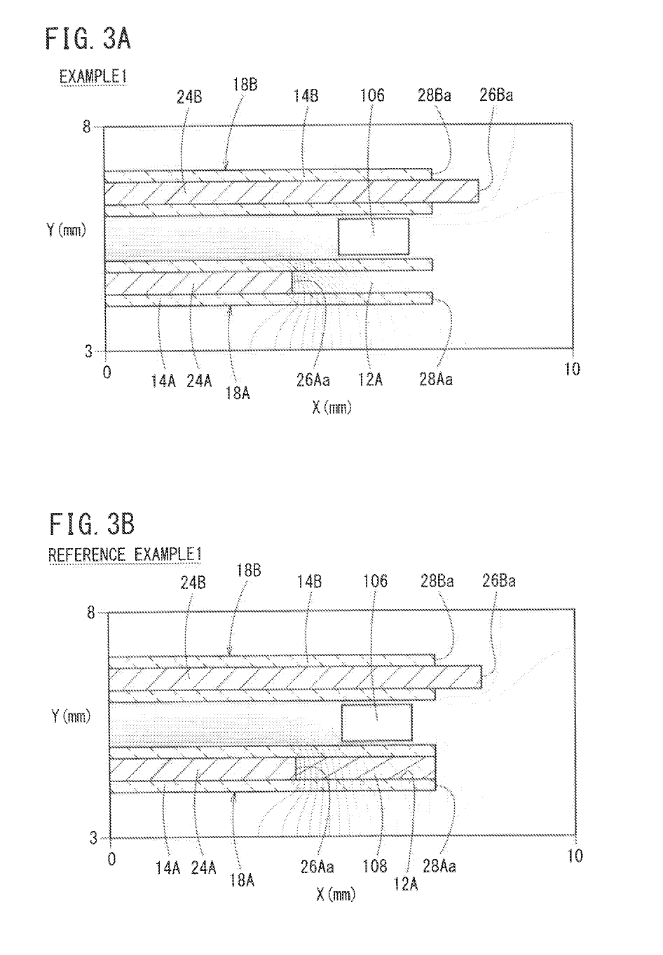

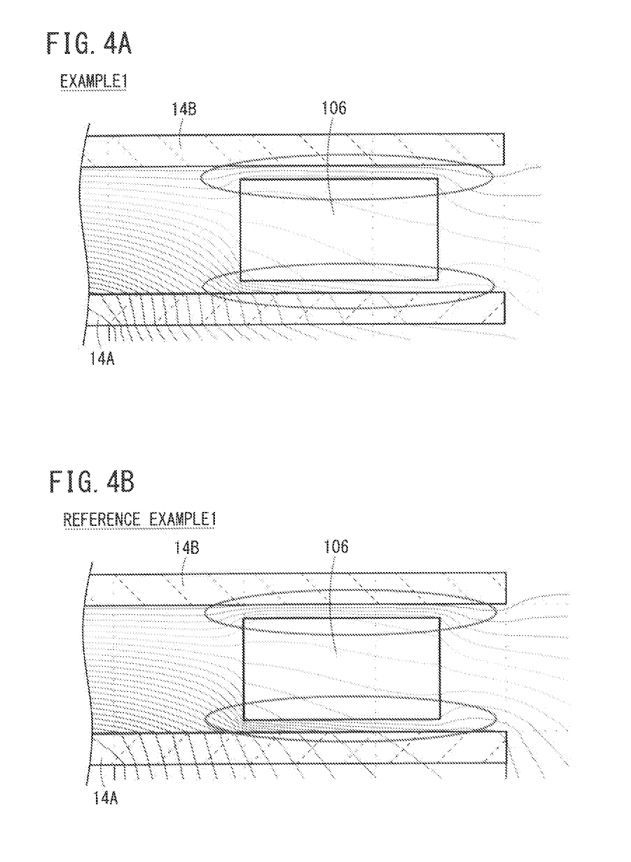

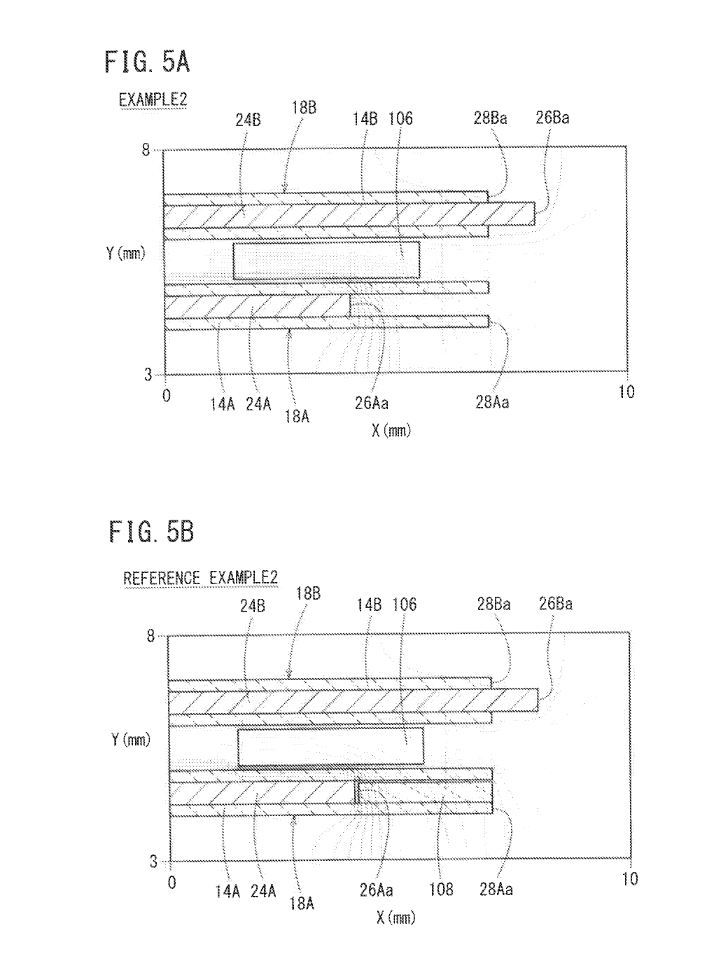

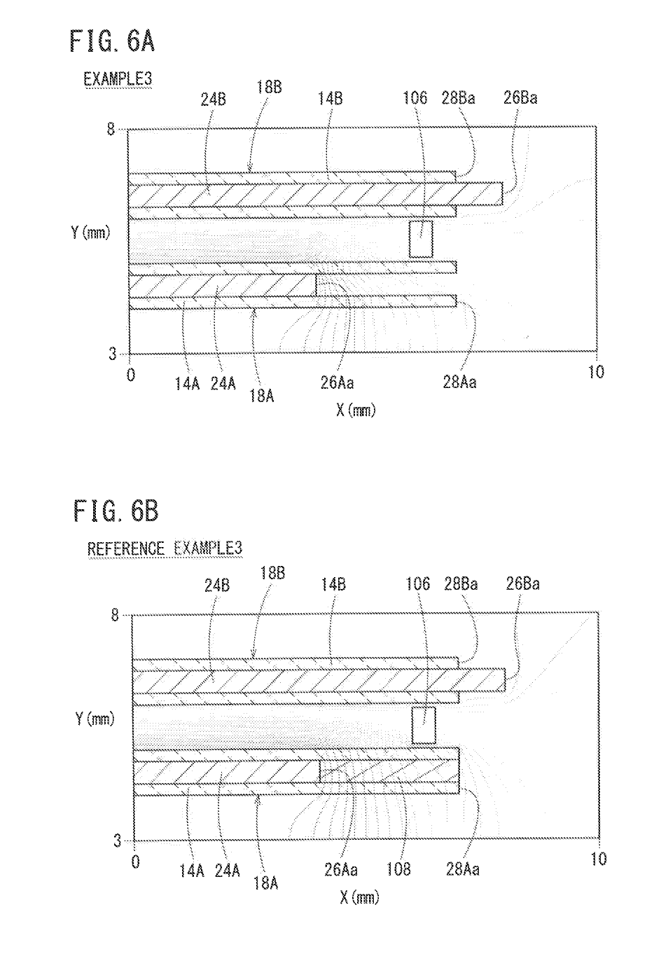

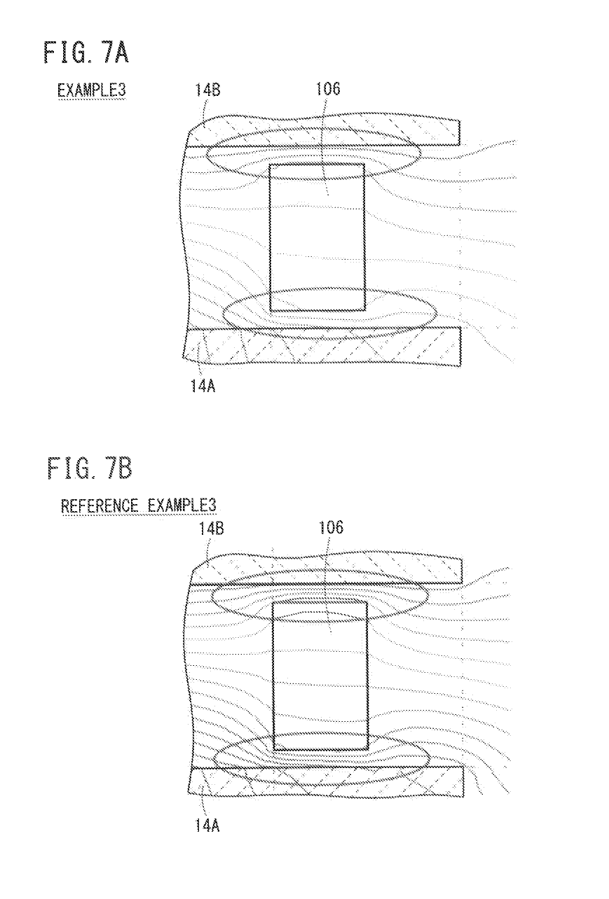

Examples 1 to 3 and Reference Examples 1 to 3, a supporting member 106 for forming a predetermined discharge gap 36 is disposed between the first electrode 18A and the second electrode 18B. The electric field distribution in each of the electrode structural bodies was observed. FIGS. 3A and 4A are equipotential line maps in a main part of Example 1, and FIGS. 3B and 4B are equipotential line maps in a main part of Reference Example 1. FIG. 5A is an equipotential line map in a main part of Example 2, and FIG. 5B is an equipotential line map in a main part of Reference Example 2. FIGS. 6A and 7A are equipotential line maps in a main part of Example 3, and FIGS. 6B and 7B are equipotential line maps in a main part of Reference Example 3.

As shown in FIG. 3A, the electrode structural body of Example 1 is similar to the electrode structural body 10. The supporting member 106 is located on the outer peripheries of the first insulating body 14A and the second insulating body 14B between a position corresponding to the one end surface 28Aa of the first insulating body 14A and a position corresponding to the one end surface 26Aa of the first conducting rod 24A. Explanations for the structure around the other end surfaces of the first insulating body 14A and the second insulating body 14B are omitted in this and the following examples.

As shown in FIG. 5A, the axial direction length of the supporting member 106 in the electrode structural body of Example 2 is longer than the axial direction length of the supporting member 106 in the electrode structural body of Example 1. The other end surface of the supporting member 106 is closer, than the one end surface 26Aa of the first conducting rod 24A, to the other side.

As shown in FIG. 6A, the axial direction length of the supporting member 106 in the electrode structural body of Example 3 is shorter than the axial direction length of the supporting member 106 in the electrode structural body of

Example 1.

As shown in FIG. 3B, in the electrode structural body of Reference Example 1, an insulating material 108, which has a permittivity equal to that of the first insulating body 14A, is inserted between the one end surface 26Aa of the first conducting rod 24A and the one end surface 28Aa of the first insulating body 14A in the first hollow portion 12A of the first electrode 18A. Thus, a solid structure is formed.

As shown in FIG. 5B, the electrode structural body of

Reference Example 2 has the solid structure similar to that of Reference Example 1, and has the supporting member 106 similar to the supporting member 106 of Example 2.

As shown in FIG. 6B, the electrode structural body of Reference Example 3 has the solid structure similar to that of Reference Example 1, and has the supporting member 106 similar to the supporting member 106 of Example 3.

In comparison between Example 1 and Reference Example 1, as shown in FIGS. 3A to 4B, the electric field strength is lower at the boundary between the supporting member 106 and the first insulating body 14A and the boundary between the supporting member 106 and the second insulating body 14B in Example 1 than in Reference Example 1.

In comparison between Example 2 and Reference Example 2, as shown in FIGS. 5A and 5B, the electric field strength is lower at the boundary between the supporting member 106 and the first insulating body 14A and the boundary between the supporting member 106 and the second insulating body 14B in Example 2 than in Reference Example 2.

In comparison between Example 3 and Reference Example 3, as shown in FIGS. 6A to 7B, the electric field strength is lower at the boundary between the supporting member 106 and the first insulating body 14A and the boundary between the supporting member 106 and the second insulating body 14B in Example 3 than in Reference Example 3.

Furthermore, in comparison between Examples 1 to 3, the electric field strength at the boundary between the supporting member 106 and the first insulating body 14A and the boundary between the supporting member 106 and the second insulating body 14B is the lowest in Example 3, and is increased in the order of Example 3, Example 1, and Example 2.

As is clear from the results, it is preferred that the retainer or the supporting member is located on the outer peripheries of the first insulating body 14A and the second insulating body 14B between a position corresponding to the one end surface 28Aa of the first insulating body 14A and a position corresponding to the one end surface 26Aa of the first conducting rod 24A.

As described above, the electrode structural body 10 of this embodiment can achieve the following advantageous effects:
(1) the sealant such as the resin or the like is not required;
(2) the sealing step is not required, whereby the assembly time can be shortened;
(3) the sealant hardening time is not required;
(4) deterioration of an insulating surface (a creepage surface) between the first conducting body 16A and the second conducting body 16B can be prevented with an improved reliability;
(5) as described above, consideration of the thermal expansion coefficient difference is not required, whereby the design possibility can be expanded, and the electrode structural body 10 can be used within a wider temperature range;
(6) the creepage distance for forming the discharge gap 36 can be reduced, whereby the electrode structural body 10 can be small-sized;
(7) the electric field strength can be lowered in a portion fixed by the retainer or the supporting member, whereby the structure of the retainer or the supporting member can be simplified, and thus the entire structure of the electrode structural body 10 can be simplified; and
(8) the electrode structural body 10 can be preferably used not only in home but also in vehicle.

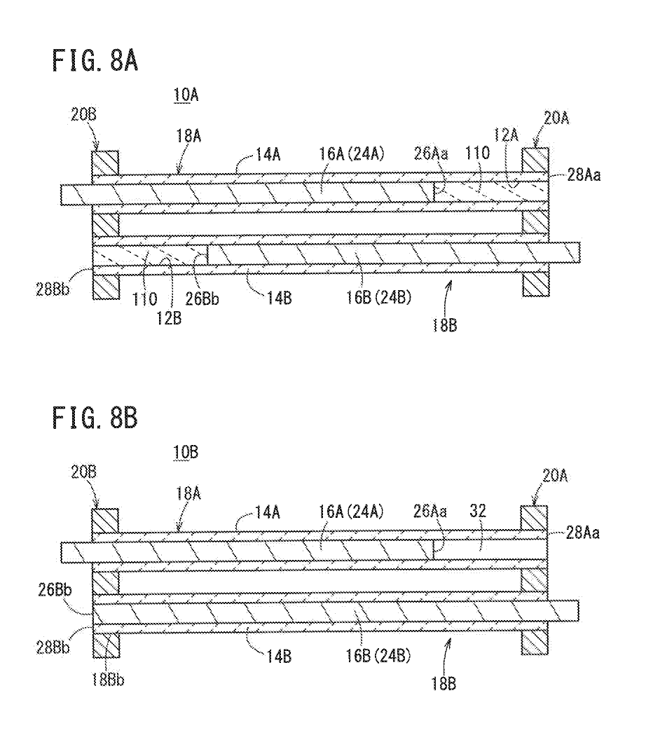

Several modification examples of the electrode structural body 10 of this embodiment will be described below with reference to FIGS. 8A and 8B.

As shown in FIG. 8A, an electrode structural body 10A according to a first modification example is similar to the electrode structural body 10 of the above embodiment, and is different from the electrode structural body 10 as follows.

In the first hollow portion 12A of the first electrode 18A, an insulating material 110, which has a permittivity lower than that of the first insulating body 14A, is present between the one end surface 26Aa of the first conducting rod 24A and the one end surface 28Aa of the first insulating body 14A. Similarly, in the second hollow portion 12B of the second electrode 18B, an insulating material 110, which has a permittivity lower than that of the second insulating body 14B, is present between the other end surface 26Bb of the second conducting rod 24B and the other end surface 28Bb of the second insulating body 14B.

As shown in FIG. 8B, an electrode structural body 10B according to a second modification example is similar to the electrode structural body 10 of the above embodiment, and is different from the electrode structural body 10 in the direct current type structure, In the second electrode 18B, the other end surface 26Bb of the second conducting rod 24B corresponds with the other end surface 28Bb of the second insulating body 14B.

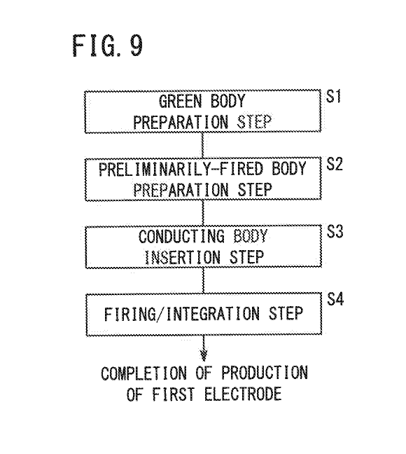

Two methods for producing the typical first electrode 18A in the electrode structural body 10 (a first production method and a second production method) will be described below with reference to FIGS. 9 to 12C.

### [First Production Method]

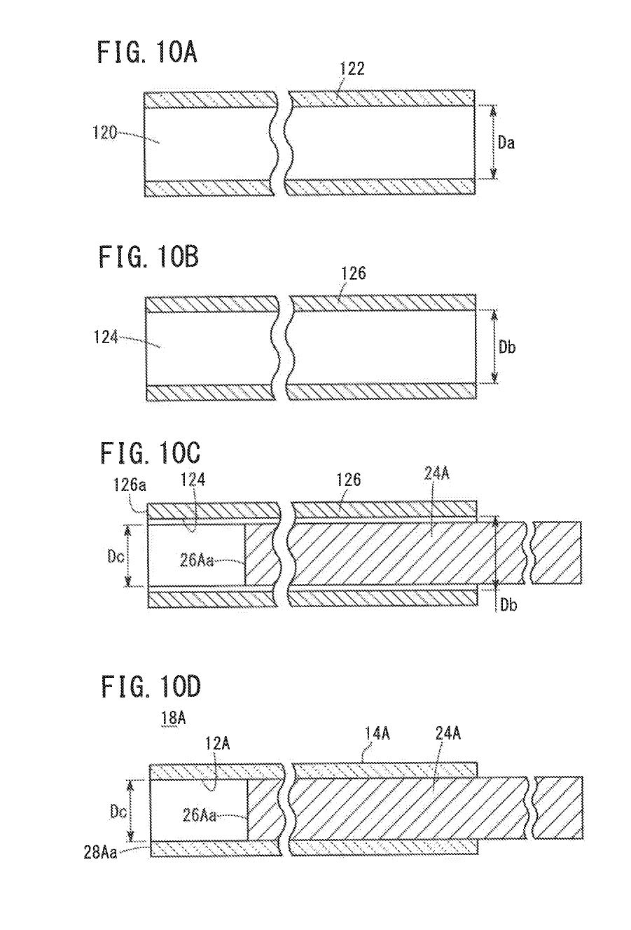

As shown in FIGS. 9 to 10D, the first production method contains a green body preparation step S1 of preparing a green body 122 (see FIG. 10A) to be formed into the first insulating body 14A, the green body 122 having a hollow portion 120, a preliminarily-fired body preparation step S2 of degreasing and preliminarily-firing the green body 122 to prepare a preliminarily-fired body 126 having a hollow portion 124 (see FIG. 10B), a conducting body insertion step S3 of inserting the first conducting rod 24A into the hollow portion 124 in the preliminarily-fired body 126, and a firing/integration step S4 of firing the preliminarily-fired body 126 together with the first conducting rod 24A inserted thereinto to produce the first electrode 18A (see FIG. 10D).

In the green body preparation step S1, a starting material slurry is shaped and solidified to prepare the green body 122. The starting material slurry contains a starting material powder, a dispersion medium, and an organic binder. In addition, the starting material slurry may contain a dispersion aid and a catalyst, as necessary. Specifically, the starting material powder may be a powder of a ceramic containing one or more elements selected from the group consisting of barium, bismuth, titanium, zinc, aluminum, silicon, magnesium, and neodymium. The dispersion medium may be a mixture of an aliphatic polyhydric ester and a polybasic acid ester, or ethylene glycol. The organic binder may be a gelling agent or the like. In a case where the green body 122 has, for example, the extruded shape with the hollow portion 120 (through-hole) as shown in FIG. 10A, the organic binder may be a substance other than the gelling agent (i.e., a substance that is hardened not by a chemical reaction but by drying only). Of course, in a case where the green body 122 has a shape different from the extruded shape, the gelling agent can be preferably used. In this case, the gelling agent may contain a substance that is hardened by a hardening reaction (a chemical reaction such as a urethane reaction). For example, the gelling agent may contain a combination of a modified polymethylene polyphenyl polyisocyanate and a polyol. The dispersion medium may be a mixture of a dibasic acid ester. The dispersion aid may be a polycarboxylic acid-based copolymer. The catalyst may be a tertiary amine, and specific examples thereof include 6-dimethylamino-1-hexanol or the like.

For example, in the case of preparing the green body 122 having the extruded shape with the through-hole being formed as the hollow portion 120, the starting material slurry can be preferably shaped by extrusion molding. The inner diameter Da of the hollow portion 120 in the green body 122 is slightly larger than the outer diameter Dc of the first conducting rod 24A (see FIG. 10C), whereby the first conducting rod 24A can be easily inserted later.

In the case of using the extrusion molding, a long body extruded from an extruder is cut into the green bodies 122 having a predetermined length, and successively the cut green bodies 122 are degreased and preliminarily-fired. Alternatively, a long body extruded from the extruder is degreased and preliminarily-fired while cut into the green bodies 122 having a predetermined length. Therefore, the steps can be continuously carried out to improve the productivity.

Of course, in the case of using the gelling agent in the organic binder, the starting material slurry may be shaped by using a mold having a molding cavity corresponding to the cylindrical (tubular) first insulating body 14A. In this case, the molding cavity of the mold is filled with the starting material slurry, whereby the starting material slurry is molded into a shape corresponding to the cylindrical (tubular) shape of the first insulating body 14A. The molded starting material slurry is solidified via the hardening reaction of the gelling agent. After that, the solidified slurry is separated from the mold (demolded), and then degreased and preliminarily-fired. This process, which contains molding the starting material slurry containing the starting material powder, the dispersion medium, and the gelling agent and solidifying the molded slurry to thereby prepare the green body 122 via the hardening reaction of the gelling agent, is known as “a gel casting process”.

In the preliminarily-fired body preparation step S2, the green body 122 is degreased and then preliminarily-fired. The degreasing is a treatment for burning to remove an organic component such as a binder from the green body 122. The green body 122 becomes brittle temporarily by the removal of the binder. The preliminarily-firing is a treatment for sintering the brittle green body 122 to some extent to obtain the preliminarily-fired body 126 strong enough to handle. Incidentally, the preliminarily-fired body 126 is not brought into a sufficiently-sintered state, wherein significant firing shrinkage does not occur. More specifically, for example, the green body 122 is preliminarily-fired in an air atmosphere at a temperature of 400° C. to 800° C. for 1 to 8 hours. In view of handling in the following step, the temperature is increased until the firing treatment proceeds to such an extent that the green body 122 can have such a sufficient strength (i.e., the preliminarily-fired body 126 is obtained). As described above, the preliminarily-fired body 126 is not significantly shrunk by sintering in this step. Therefore, the inner diameter Db of the hollow portion 124 in the preliminarily-fired body 126 is approximately equal to the inner diameter Da of the hollow portion 120 in the green body 122, and the first conducting rod 24A can be easily inserted thereinto.

In the conducting body insertion step S3, as shown in FIG. 10C, the solid first conducting rod 24A per se is inserted into the hollow portion 124 in the thus-prepared preliminarily-fired body 126. Though the first conducting rod 24A is placed at the center of the hollow portion 124 in FIG. 10C, the first conducting rod 24A may be brought into partial contact with the inner wall surface of the hollow portion 124 in or after the process of inserting the first conducting rod 24A. The first conducting rod 24A is inserted in such a manner that the one end surface 26Aa of the first conducting rod 24A does not reach one end surface 126a of the preliminarily-fired body 126 and is positioned inside the hollow portion 124.

The preliminarily-fired body 126 has a stiffness property. Therefore, the first conducting rod 24A can be easily inserted into the hollow portion 124 in the preliminarily-fired body 126, and the preliminarily-fired body 126 can be easily handled. Thus, the first conducting rod 24A can be automatically inserted using a robot or the like while the preliminarily-fired body 126 is conveyed. For example, the first conducting rod 24A may be a cylindrical solid made of a metal or cermet material containing molybdenum or a molybdenum alloy. In the following firing step, the preliminarily-fired body 126 is subjected to firing shrinkage, while the first conducting rod 24A is not shrunk by the firing. Thus, the outer diameter Dc of the first conducting rod 24A is set to be smaller than the inner diameter Db of the hollow portion 124 (through-hole) in the preliminarily-fired body 126 (see FIG. 10C) by the amount of the firing shrinkage of the preliminarily-fired body 126. When only the green body 122 is fired, the resultant has a particular inner diameter. In a case where the outer diameter Dc of the first conducting rod 24A is slightly larger (specifically by more than 0 μm and at most 10 μm) than the particular inner diameter, the first conducting rod 24A and the preliminarily-fired body 126 can be integrated with an improved adhesion.

In the firing/integration step S4, the preliminarily fired body 126 is fired together with the first conducting rod 24A inserted thereinto. For example, the firing is carried out in an oxygen-free atmosphere (such as a nitrogen or argon atmosphere). The oxygen-free atmosphere is not limited to an atmosphere completely free from oxygen, and may be, for example, the following atmosphere (a) or (b): (a) an atmosphere provided by introducing nitrogen or argon into a firing furnace, while discharging air from the firing furnace, to replace the air by the nitrogen or argon; or (b) an atmosphere provided by introducing nitrogen or argon into the firing furnace after vacuating the firing furnace.

In the firing/integration step, the firing temperature is 900° C. to 1600° C., preferably 900° C. to 1050° C. When the firing temperature is within the preferred range, the range of choice for the material of the conducting body can be enlarged. For example, in the case of using an alumina as the material for the insulating body, the upper limit of the firing temperature is 1600° C. The firing time is 1 to 10 hours.

The firing treatment may be carried out while maintaining an atmosphere containing a small amount of oxygen. However, in the case of performing the firing in the oxygen-free atmosphere as described above, it is not necessary to control the atmosphere containing a small amount of oxygen, and the first insulating body 14A can be easily sintered while oxidation of the first conducting rod 24A is prevented.

The preliminarily-fired body 126 is shrunk by the firing. As a result, a so-called shrinkage fitting of the first conducting rod 24A is achieved. Thus, the fired first insulating body 14A and the first conducting rod 24A are strongly connected and integrated with each other. Consequently, the first electrode 18A is produced, which contains the first conducting rod 24A embedded in the first hollow portion 12A of the first insulating body 14A. The one end surface 26Aa of the first conducting rod 24A is positioned inside the first hollow portion 12A at a distance from the one end surface 28Aa of the first insulating body 14A. The second electrode 18B can be produced in the same manner.

An intermediate layer containing a main component (such as molybdenum) of the first conducting rod 24A may be formed at the boundary between the first insulating body 14A and the first conducting rod 24A. The intermediate layer is formed due to diffusion of the main component of the first conducting rod 24A into the first insulating body 14A in the firing treatment. The first insulating body 14A on the first conducting rod 24A has no pores inside with a size of 50 μm or more. In a case where the first insulating body 14A has a relatively high percentage of porosity, breakdown may be rapidly caused due to a voltage applied to the ceramic. In a case where the first insulating body 14A has only one closed pore having a size of 50 μm, the breakdown may be started from the closed pore, and an arc plasma may be generated to melt the ceramic. It is ideal that the first insulating body 14A does not have such closed pores. It is preferred that all closed pores dispersed in the material have a diameter of less than 10 μm.

### [Second Production Method]

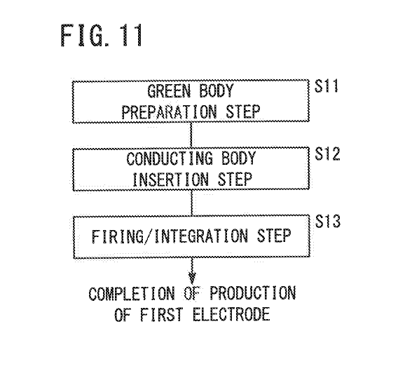

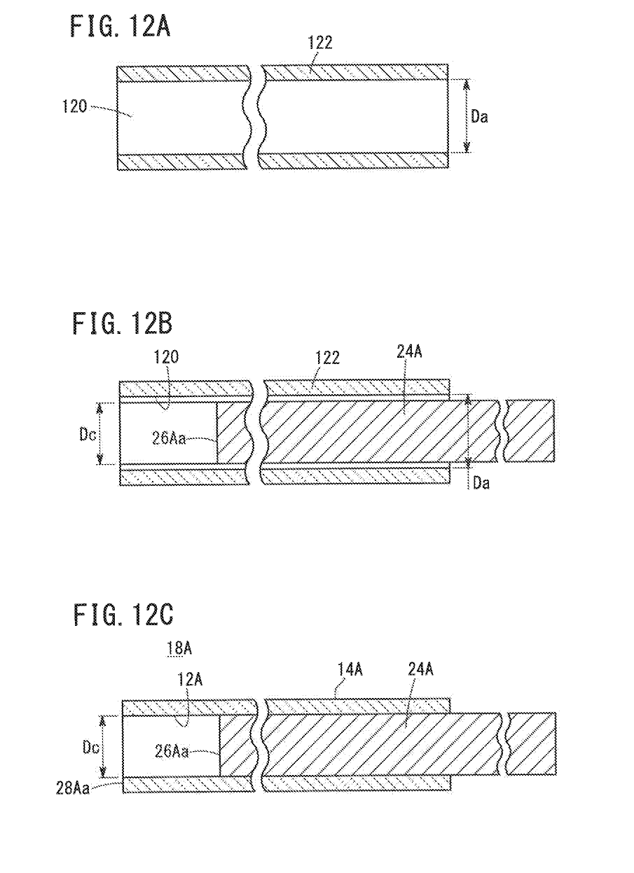

As shown in FIGS. 11 to 12C, the second production method contains a green body preparation step S11 of preparing a green body 122 (see FIG. 12A) to be formed into the first insulating body 14A, the green body 122 having a hollow portion 120, a conducting body insertion step S12 of inserting the first conducting rod 24A into the hollow portion 120 in the green body 122, and a firing/integration step S13 of firing the green body 122 together with the first conducting rod 24A inserted thereinto to produce the first electrode 18A.

In the green body preparation step S11, the starting material slurry is shaped and solidified to prepare the green body 122 shown in FIG. 12A in the same manner as the green body preparation step S1 in the first production method.

In the conducting body insertion step S12, as shown in FIG. 12B, the solid first conducting rod 24A is inserted into the hollow portion 120 in the prepared green body 122. Though the first conducting rod 24A is placed at the center of the hollow portion 120 in FIG. 12B, the first conducting rod 24A may be brought into partial contact with the inner wall surface of the hollow portion 120 in or after the process of inserting the first conducting rod 24A. In the following firing step, the green body 122 is subject to firing shrinkage, while the first conducting rod 24A is not shrunk by the firing. Thus, the outer diameter Dc of the first conducting rod 24A is set to be smaller than the inner diameter Da of the hollow portion 120 (through-hole) in the green body 122 by the amount of the firing shrinkage of the green body 122. When only the green body 122 is fired, the resultant has a particular inner diameter. In a case where the outer diameter Dc of the first conducting rod 24A is slightly larger (specifically by more than 0 μm and at most 10 μm) than the particular inner diameter, the components can be integrated with an improved adhesion.

In the firing/integration step S13, the green body 122 is fired together with the first conducting rod 24A inserted thereinto. For example, the firing is carried out in a weakly oxidizing atmosphere containing an inert gas such as a humidified nitrogen or argon gas (an atmosphere having a low oxygen partial pressure) at a temperature of 900° C. to 1600° C. (preferably 900° C. to 1050° C.) for 1 to 20 hours. The humidification is achieved by bubbling of the inert gas in water having a temperature of 10° C. to 80° C. The firing is carried out in the weakly oxidizing atmosphere because of the following reasons:
(1) a certain level of oxidizing atmosphere is required for firing and removing the gelling agent; and
(2) the oxygen partial pressure in the oxidizing atmosphere is required to be small in order to prevent excess oxidation of the first conducting rod 24A.

In the above firing, the green body 122 is subjected to firing shrinkage. As a result, a so-called shrinkage fitting of the first conducting rod 24A is achieved. Thus, the fired first insulating body 14A and the first conducting rod 24A are strongly connected and integrated with each other.

In the first and second production methods, in the case of using the gel casting process in the green body preparation steps S1 and S11, a submicron starting material powder can be used and significantly uniformly distributed in the green body 122. Therefore, the firing shrinkage ratio can be highly accurately controlled, and a dense sintered body (the first insulating body 14A) can be prepared without defects. The denseness is effective in improving the voltage resistance of the electrode.

To produce the first electrode 18A, a method containing the steps of preparing the first conducting rod 24A and the first insulating body 14A separately, inserting the first conducting rod 24A into the first hollow portion 12A of the first insulating body 14A, and bonding the components with a resin or the like may be used instead of the above methods. Alternatively, a method containing filling the first hollow portion 12A of the first insulating body 14A with a conducting paste may be used. However, in the former method, the product cannot exhibit a sufficient durability at a high temperature because of the heat resistance of the resin. In the latter method, it is difficult to form the dense conducting body, and an abnormal electrical discharge is often generated.

Therefore, it is preferred that the first conducting rod 24A is inserted into the hollow portion 124 of the preliminarily-fired body 126, and then the preliminarily-fired body 126 and the first conducting rod 24A are directly integrated with each other by firing as in the above first and second production methods. The second electrode 18B is preferably produced in the same manner.

It is to be understood that the electrode and the electrode structural body of the present invention are not limited to the above embodiments, and various changes and modifications may be made therein without departing from the scope of the invention.

What is claimed:

1. An electrode comprising a cylindrical insulating body having a hollow portion and a conducting body located in the hollow portion of the insulating body, wherein
at least one end surface of the conducting body is positioned inside the hollow portion at a distance from one end surface of the insulating body.

2. The electrode according to claim 1, wherein
a substance, which has a permittivity lower than that of the insulating body, is present between the one end surface of the conducting body and the one end surface of the insulating body in the hollow portion.

3. The electrode according to claim 1, wherein
the substance is air.

4. The electrode according to claim 1, wherein
the insulating body and the conducting body are directly integrated with each other by firing.

5. An electrode structural body comprising:
a first electrode containing a cylindrical first insulating body having a first hollow portion and a first conducting body located in the first hollow portion of the first insulating body;
a second electrode containing a cylindrical second insulating body having a second hollow portion and a second conducting body located in the second hollow portion of the second insulating body; and
a retainer configured to fix the first electrode and the second electrode,
wherein the first electrode and the second electrode are separated from each other, their axial directions being parallel to each other, and
at least in the first electrode, at least one end surface of the first conducting body is positioned inside the first hollow portion at a distance from one end surface of the first insulating body.

6. The electrode structural body according to claim 5, wherein
a substance, which has a permittivity lower than that of the first insulating body, is present between the one end surface of the first conducting body and the one end surface of the first insulating body in the first hollow portion.

7. The electrode structural body according to claim 6, wherein
the substance is air.

8. The electrode structural body according to claim 5, wherein
at least the retainer is located on outer peripheries of the first insulating body and the second insulating body between a position corresponding to the one end surface of the first insulating body and a position corresponding to the one end surface of the first conducting body.

9. The electrode structural body according to claim 5, wherein
in the second electrode, at least another end surface of the second conducting body is positioned inside the second hollow portion at a distance from another end surface of the second insulating body.

10. The electrode structural body according to claim 9, wherein
a substance, which has a permittivity lower than that of the first insulating body, is present between the one end surface of the first conducting body and the one end surface of the first insulating body in the first hollow portion, and
a substance, which has a permittivity lower than that of the second insulating body, is present between the other end surface of the second conducting body and the other end surface of the second insulating body in the second hollow portion.

11. The electrode structural body according to claim 10, wherein
the substance is air.

12. The electrode structural body according to claim 9, wherein
the retainer contains a first retainer and a second retainer,
the first retainer is located on the outer peripheries of the first insulating body and the second insulating body between a position corresponding to the one end surface of the first insulating body and a position corresponding to the one end surface of the first conducting body, and
the second retainer is located on the outer peripheries of the first insulating body and the second insulating body between a position corresponding to the other end surface of the second insulating body and a position corresponding to the other end surface of the second conducting body.

13. The electrode structural body according to claim 5, wherein
the first insulating body and the first conducting body are directly integrated with each other by firing, and
the second insulating body and the second conducting body are directly integrated with each other by firing.
